(19) United States
(12) Patent Application Publication
(10) Pub. No.: US 2020/0302700 A1
(43) Pub. Date: Sep. 24, 2020

(54) TRANSIT RANGE EVALUATION DEVICE, TRANSIT RANGE EVALUATION SYSTEM, TRANSIT RANGE EVALUATION METHOD, AND PROGRAM

(71) Applicant: MITSUBISHI HEAVY INDUSTRIES MACHINERY SYSTEMS, LTD, Hyogo (JP)

(72) Inventors: Yoshifumi HAYAKAWA, Tokyo (JP); Tomoya KAGA, Tokyo (JP)

(21) Appl. No.: 16/088,495

(22) PCT Filed: Mar. 31, 2017
(86) PCT No.: PCT/JP2017/013614

§ 371 Date: Sep. 26, 2018

(30) Foreign Application Priority Data
Mar. 31, 2016 (JP) 2016-073573

(51) Int. Cl. G07B 15/06; G06Q 30/02; H04W 4/40

(52) U.S. Cl. CPC G07B 15/063; H04W 4/40; G06Q 30/0284

(57) ABSTRACT

In a transit range evaluation device according to the present application, an acquisition unit acquires vehicle identification information for identifying a vehicle from an identification information reading device disposed in individual detection areas of a main road to be monitored, the detection areas being partitioned at connection points connecting the main road and branch roads. The vehicle identification information, the detection time of the vehicle identification information, and the detection area in which the detection is performed are correlated in detection information, which is recorded in a detection information storage unit by a detection information recording unit. A range specification unit specifies the transit range on a main road in which a vehicle indicated by the vehicle identification information traveled, on the basis of the detection information recorded in the detection information storage unit.

### TECHNICAL FIELD

This invention relates to a transit range evaluation device, a transit range evaluation system, a transit range evaluation method, and a program.

This application claims priority based on JP 2016-073573 filed in Japan on Mar. 31, 2016, of which the contents are incorporated herein by reference.

### BACKGROUND ART

In a toll collection system for toll roads, it is desired for vehicles traveling on toll roads to be reliably discriminated to prevent a charging process from being performed on a wrong vehicle. For this reason, in Electronic Toll Collection System (ETC) (trade name, also referred to as Automatic Toll Collection System), a tollgate is separated into single lanes so that communication can be reliably made with each individual vehicle.

Patent Document 1 discloses a technique of collecting a uniform toll at an entrance tollgate and reducing or additionally collecting the toll by adopting a free flow method at an exit tollgate.

### CITATION LIST

### Patent Document

Patent Document 1: JP 2005-085046 A

### SUMMARY OF INVENTION

### Problem to be Solved by the Invention

When a tollgate is separated into single lanes (with a relatively narrow width), vehicles passing through the tollgate are required to travel at a speed lower than a toll road speed from the perspective of securing safety. In this way, when a tollgate separated into single lanes is disposed, traffic capacity of a road around the tollgate may be reduced, causing smooth passage to be hindered.

An object of the present invention is to provide a transit range evaluation device, a transit range evaluation system, a transit range evaluation method, and a program, capable of specifying a transit range on a main road traveled by each vehicle, without disposing a tollgate separated into single lanes at an entrance or an exit of a main road.

### Solution to Problem

According to a first aspect of the present invention, a transit range evaluation device 200 includes an acquisition unit 201 configured to acquire vehicle identification information for identifying a vehicle C from an identification information reading device 100 disposed in individual detection areas of a main road R1 to be monitored, the detection areas being partitioned at connection points P connecting the main road and branch roads R2, R3, a detection information recording unit 207 configured to record detection information in a detection information storage unit 206, wherein vehicle identification information, a detection time of the vehicle identification information, and the detection area in which the vehicle identification information is detected, are associated with the detection information, and a range specification unit 209 configured to specify a transit range on the main road in which the vehicle indicated by the vehicle identification information traveled, based on the detection information recorded in the detection information storage unit.

This thereby enables the transit range evaluation device to specify the transit range on the main road in which the vehicle traveled, based on information obtainable from the identification information reading device disposed on a main road. Also, since there is no need to dispose a tollgate separated into single lanes at an exit or entrance of a main road, reduction of traffic capacity of the main road at an exit or entrance may be suppressed.

According to a second aspect of the present invention, in a transit range evaluation device of the first aspect, in a case where a vehicle identification information is not acquired again before a predetermined amount of time passes after a time in which the vehicle identification information has been last acquired, the range specification unit is configured to specify, out of the connection points, one adjacent a downstream side of the detection area in which the vehicle identification information has been last acquired, as an exit side end of the transit range of the vehicle indicated by the vehicle identification information.

This thereby enables the transit range evaluation device to specify the exit side end of the transit range, based on the information obtainable from the identification information reading device disposed in a detection area.

According to a third aspect of the present invention, in a transit range evaluation device of the first or second aspect, in a case where a vehicle identification information is not acquired within a predetermined amount of time after a time in which the vehicle identification information has been acquired, the range specification unit is configured to specify, out of the connection points, one adjacent an upstream side of the detection area in which the vehicle identification information has been acquired, as an entry side end of the transit range of the vehicle indicated by the vehicle identification information.

This thereby enables the transit range evaluation device to specify the respective transit range of a vehicle, even if the vehicle enters the main road multiple number of times in a short period of time.

According to a fourth aspect of the present invention, in a transit range evaluation device of any of the first to third aspects, in a case where a first detection area in which a vehicle identification information is acquired and a second detection area in which the vehicle identification information has been detected immediately prior to a detection of the vehicle identification information in the first detection area are not adjacent to each other, the range specification unit is configured to specify, out of the connection points, one adjacent the upstream side of the first detection area as an entry side end of a first transit range of the vehicle indicated by the vehicle identification information, and to specify, out of the connection points, one adjacent the downstream side of the second detection area as an exit side end of a second transit range of the vehicle indicated by the vehicle identification information.

This thereby enables the transit range evaluation device to specify the entry side end of the transit range, based on the information obtainable from the identification information reading device disposed in a detection area.

According to a fifth aspect of the present invention, a transit range evaluation device of any of the first to fourth aspects further includes an auxiliary acquisition unit 212 configured to acquire vehicle identification information from an identification information reading device disposed in the branch road, and in a case where a vehicle identification information is acquired by the auxiliary acquisition unit, the range specification unit is configured to specify the connection point connected to the branch road in which the vehicle identification information is acquired, as an end of the transit range of the vehicle indicated by the vehicle identification information.

This thereby enables the transit range evaluation device to quickly specify the end of a transit range.

According to a sixth aspect of the present invention, a transit range evaluation device of any of the first to fifth aspects further includes a reception unit 213 configured to receive, from a mobile terminal possessed by a user, transit information that is information relating to travel on the main road by a vehicle used by the user, wherein the range specification unit is configured to specify the transit range based on the transit information received by the reception unit and the detection information recorded in the detection information storage unit.

In this way, the transit range evaluation device specifies the transit range based on information obtainable from a mobile terminal in addition to the information obtainable from an identification information reading device. This enables the transit range evaluation device to more reliably specify the transit range.

According to a seventh aspect of the present invention, in a transit range evaluation device of the sixth aspect, the transit information includes information indicating the detection area or the branch road traveled by a vehicle used by the user.

This thereby enables the transit range evaluation device to more reliably specify the transit range.

According to an eighth aspect of the present invention, in a transit range evaluation device of the sixth or seventh aspect, the transit information includes information indicating that a vehicle used by the user exited from the main road, and the range specification unit is configured to specify the transit range based on the detection information recorded in the detection information storage unit, the detection information being recorded prior to a time of reception of the transit information indicating an exit from the main road.

This thereby enables the transit range evaluation device to quickly specify the transit range.

According to a ninth aspect of the present invention, a transit range evaluation device of any of the first to eight aspects, further includes a toll calculation unit 210 configured to calculate a toll to be charged to the vehicle based on the transit range specified by the range specification unit.

This thereby enables the transit range evaluation device to calculate the traffic of each vehicle accurately.

According to a tenth aspect of the present invention, a transit range evaluation system 1 includes an identification information reading device 100 disposed in individual detection areas of a main road to be monitored, the detection areas being partitioned at connection points connecting the main road and branch roads, and a transit range evaluation device 200 of any of the first to ninth aspects.

According to an eleventh aspect of the present invention, a transit range evaluation method includes an acquisition step (S202) of acquiring vehicle identification information for identifying a vehicle from an identification information reading device disposed in individual detection areas of a main road to be monitored, the detection areas being partitioned at connection points connecting the main road and branch roads, a recording step (S104) of recording detection information in a detection information storage unit, wherein vehicle identification information, a detection time of the vehicle identification information, and the detection area in which the vehicle identification information is detected, are associated with the detection information, and range specification steps (S106, S109, S112, S204) of specifying the transit range on the main road in which the vehicle indicated by the vehicle identification information traveled, based on the detection information recorded in the detection information storage unit.

According to a twelfth aspect of the present invention, a program causes a computer (900) to function as, an acquisition unit configured to acquire vehicle identification information for identifying a vehicle from an identification information reading device disposed in individual detection areas of a main road to be monitored, the detection areas being partitioned at connection points connecting the main road and branch roads, a detection information recording unit configured to record detection information in a detection information storage unit, wherein a vehicle identification information, a detection time of the vehicle identification information, and the detection area in which the vehicle identification information is detected, are associated with the detection information, and a range specification unit configured to specify the transit range on the main road in which the vehicle indicated by the vehicle identification information traveled, based on the detection information recorded in the detection information storage unit.

### Advantageous Effect of Invention

According to at least one aspect of the aspects described above, a transit range evaluation device is capable of specifying a transit range on a main road traveled by each vehicle, without disposing a tollgate separated into single lanes at an entrance or an exit of the main road.

### BRIEF DESCRIPTION OF DRAWINGS

FIG. 1 is a diagram illustrating an overall configuration of a toll collection system according to a first embodiment.

FIG. 2 is a schematic block diagram illustrating a functional configuration of a toll collecting device according to the first embodiment.

FIG. 3 is a flowchart illustrating entry end specification processing by the toll collecting device according to the first embodiment.

FIG. 4 is a flowchart illustrating exit end specification processing by the toll collecting device according to the first embodiment.

FIG. 5 is a flowchart illustrating a charging process by the toll collecting device according to the first embodiment.

FIG. 6 is a diagram illustrating an overall configuration of a toll collection system according to a second embodiment.

FIG. 7 is a schematic block diagram illustrating a functional configuration of a toll collecting device according to the second embodiment.

FIG. 8 is a flowchart illustrating a process of specifying entry and exit by the toll collecting device according to the second embodiment.

FIG. 9 is a schematic block diagram illustrating a functional configuration of a toll collecting device according to a third embodiment.

FIG. 10 is a flowchart illustrating a process of receiving transit information by the toll collecting device according to the third embodiment.

FIG. 11 is a schematic block diagram illustrating a computer configuration according to at least one of the embodiments.

### DESCRIPTION OF EMBODIMENTS

### First Embodiment

A detailed description of embodiments of the toll collection system according to the first embodiment will follow with reference to the drawings.

### Overall Configuration

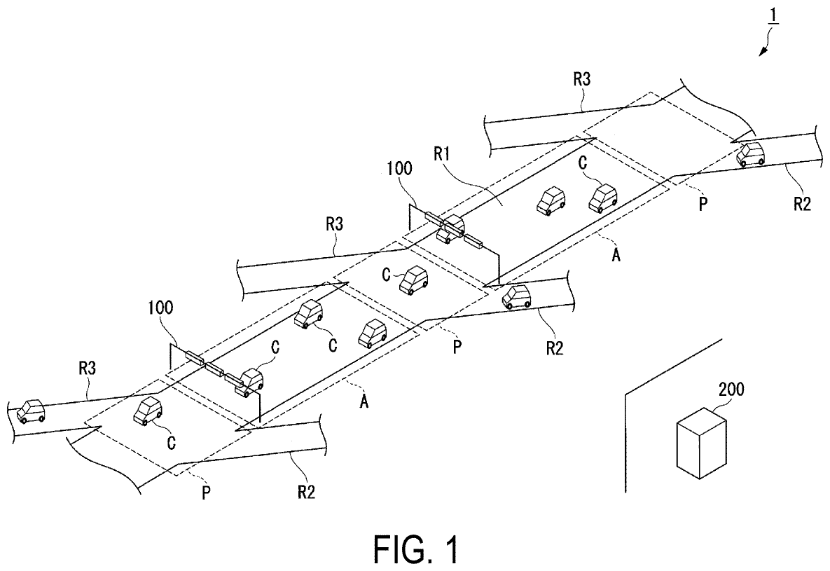

FIG. 1 is a diagram illustrating an overall configuration of the toll collection system according to the first embodiment. The toll collection system 1 according to the first embodiment is a system that charges a toll to a vehicle C that travels a main road R1 which is a toll road. The toll collection system 1 is an example of a transit range evaluation system. An entrance road R2 serving as an entrance to the main road R1 and an exit road R3 serving as an exit from the main road R1 are connected to the main road R1. The entrance road R2 and the exit road R3 are examples of branch roads connected to the main road R1. Hereinafter, a portion of the main road R1 connected to at least one of the entrance road R2 and the exit road R3 is referred to as a connection point P. The connection point P is not limited to a mathematical point having no area and length but may be a point having a certain area or length. Also, of the main road R1, an area partitioned by the connection points P is referred to as a detection area A.

As illustrated in FIG. 1, the toll collection system 1 includes an identification information reading device 100 and a toll collecting device 200.

The identification information reading device 100 is provided in each detection area A. In one detection area A, one or more identification information reading devices 100 are provided. The identification information reading device 100 reads, from the vehicle C that travels the detection area A, a vehicle ID (vehicle identification information) identifying the vehicle C. Examples of the identification information reading device 100 include a license plate recognition device that reads the vehicle ID displayed on a license plate of the vehicle C and an antenna that reads the vehicle ID from an onboard unit mounted on the vehicle C. Examples of the vehicle IDs include license plate information, onboard unit management numbers unique to each onboard unit, a vehicle identification number, and the like. In each detection area A, a sufficient number of identification information reading devices 100 are provided so as to satisfy required accuracy.

A toll collecting device 200 acquires the vehicle ID from the identification information reading device 100 and charges the toll corresponding to the transit range on the main road R1 to each vehicle C based on the acquired vehicle ID. The toll collecting device 200 is an example of a transit range evaluation device. The toll collecting device 200 is disposed at a remote place.

### Functional Configuration

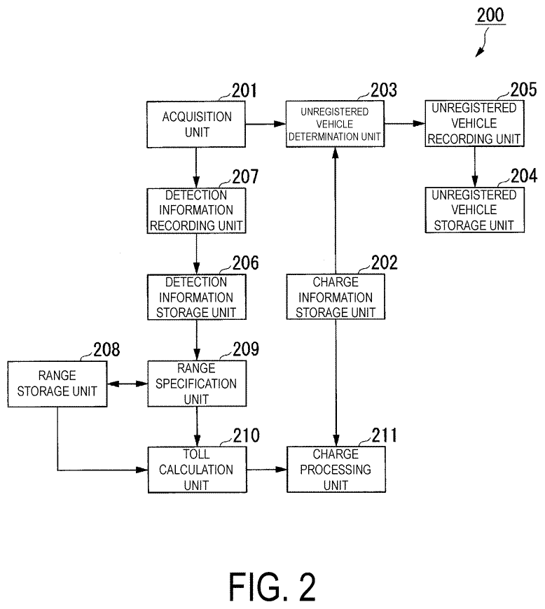

FIG. 2 is a schematic block diagram illustrating a functional configuration of the toll collecting device according to the first embodiment.

The toll collecting device 200 includes an acquisition unit 201, a charge information storage unit 202, an unregistered vehicle determination unit 203, an unregistered vehicle storage unit 204, an unregistered vehicle recording unit 205, a detection information storage unit 206, a detection information recording unit 207, a range storage unit 208, a range specification unit 209, a toll calculation unit 210, and a charge processing unit 211.

The acquisition unit 201 acquires, from the identification information reading device 100, the vehicle ID read by the identification information reading device 100.

The charge information storage unit 202 stores the vehicle ID of the vehicle C and the payment method of the toll associated with each other for each vehicle C. Examples of payment methods include an account number, a credit card number, and a billing address.

The unregistered vehicle determination unit 203 determines whether the vehicle ID acquired by the acquisition unit 201 is stored in the charge information storage unit 202.

The unregistered vehicle storage unit 204 stores the vehicle ID of a vehicle C for which the payment method is not recorded in the charge information storage unit 202 in order for an administrator to identify a vehicle C which has not paid the toll.

The unregistered vehicle recording unit 205 records the vehicle ID in the unregistered vehicle storage unit 204 when it is determined by the unregistered vehicle determination unit 203 that the vehicle ID is not stored in the charge information storage unit 202.

The detection information storage unit 206 stores detection information in which the vehicle ID, the area ID which is the identification information of the detection area A in which the vehicle ID is detected, and a time in which the vehicle ID is read are associated with each other.

Each time the acquisition unit 201 acquires the vehicle ID, the detection information recording unit 207 associates the vehicle ID, the area ID of the detection area A disposed with the identification information reading device 100 from which the vehicle ID was acquired, and the time in which the vehicle ID was read, with each other, and records them in the unregistered vehicle storage unit 204.

The range specification unit 209 specifies the transit range of the vehicle C based on the detection information stored in the detection information storage unit 206.

The range storage unit 208 stores an entry side end and an exit side end of the transit range specified by the range specification unit 209 for each vehicle C.

The toll calculation unit 210 calculates the toll based on the transit range specified by the range specification unit 209. The toll calculation unit 210 calculates the toll, for example, in accordance with a table in which transit ranges and tolls are associated.

For each vehicle C that traveled the main road R1, the charge processing unit 211 charges the toll calculated by the toll calculation unit 210, according to the payment method stored in the charge information storage unit 202 associated with the vehicle ID of the vehicle C.

### Process Flow of Toll Collecting Device

Here, operation of the toll collecting device 200 will be described. Each time the toll collecting device 200 reads the vehicle ID from the identification information reading device 100, the toll collecting device 200 executes the following entry end specification processing.

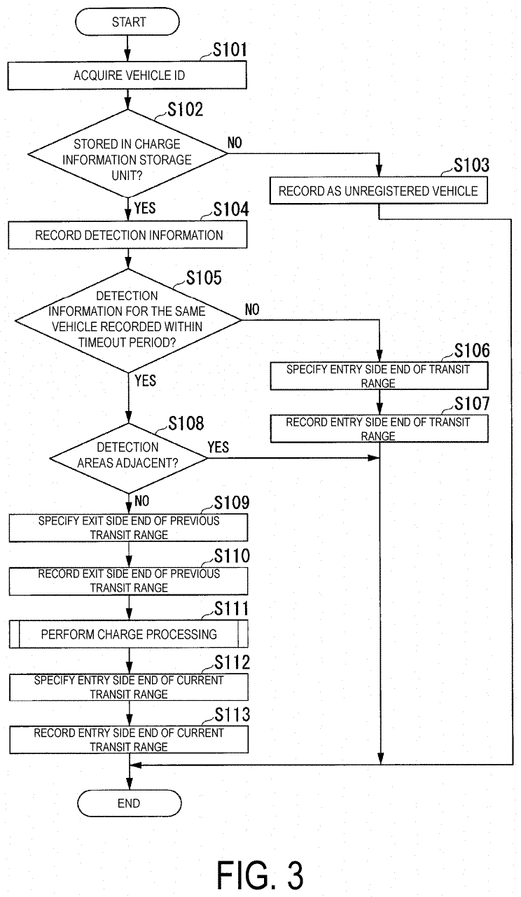

FIG. 3 is a flowchart illustrating the entry end specification processing by the toll collecting device according to the first embodiment.

When the identification information reading device 100 reads the vehicle ID, the acquisition unit 201 of the toll collecting device 200 acquires the vehicle ID from the identification information reading device 100 (step S101). Next, the unregistered vehicle determination unit 203 determines whether the vehicle ID acquired by the acquisition unit 201 is stored in the charge information storage unit 202 (step S102). When the acquired vehicle ID is not stored in the charge information storage unit 202 (step S102: NO), the unregistered vehicle recording unit 205 records the acquired vehicle ID in the unregistered vehicle storage unit 204 (step S103), associating it with the area ID of the detection area A disposed with the identification information reading device 100 that reads the vehicle ID and the detection time, and ends the entry end specification processing. This thereby enables the administrator to specify, by checking the information stored in the unregistered vehicle storage unit 204 later, a vehicle C that traveled the main road R1 without paying the toll.

On the other hand, when the acquired vehicle ID is stored in the charge information storage unit 202 (step S102: YES), the detection information recording unit 207 records the detection information regarding the acquired vehicle ID in the detection information storage unit 206 (Step S104). More specifically, the detection information recording unit 207 records the acquired vehicle ID in the detection information storage unit 206, associating it with the area ID of the detection area A disposed with the identification information reading device 100 that reads the vehicle ID and the detection time. Next, the range specification unit 209 determines whether detection information regarding the same vehicle ID was stored in the storage unit 206 (step S105) within a predetermined timeout period (24 hours, for example) prior to a detection time of the detection information recorded by the detection information recording unit 207. The detection information regarding the same vehicle ID recorded by the detection information recording unit 207 within the timeout period prior to the detection time is hereinafter referred to as immediately preceding detection information.

When no immediately preceding detection information is stored in the detection information storage unit 206 (step S105: NO), the range specification unit 209 specifies the entry side end of the transit range of the vehicle C (a vehicle specified by the vehicle ID, a vehicle pertaining to the vehicle ID) indicated by the vehicle ID of the detection information recorded in step S104 (step S106). More specifically, the range specification unit 209 specifies a connecting point P adjacent an upstream side of the detection area A indicated by the area ID of the detection information recorded in step S104, as the entry side end of the transit range of the vehicle C indicated by the vehicle ID of the detection information. Then, the range specification unit 209 records in the range storage unit 208 a connection point ID, which is identification information of the connection point P, as the entry side end of the transit range (step S107), associating the connection point ID with the vehicle ID, and ends the entry end specification processing. As described above, in a case where other detection information pertaining to the same vehicle ID as the detection information recorded in step S104 was recorded before the timeout period prior to the detection time of the detection information recorded in step S104, the range specification unit 209 specifies the entry side end of the transit range. This is because, in step S203 to be described later, when the detection information pertaining to the vehicle ID stored in the detection information storage unit 206 is not detected within the timeout period, the vehicle indicated by the vehicle ID is treated as having exited.

Conversely, when immediately preceding detection information is stored in the detection information storage unit 206 (step S105: YES), the range specification unit 209 determines whether the detection area A indicated by the area ID of the immediately preceding detection information having a latest detection time among the immediately preceding detection information is an area adjacent to the detection area A indicated by the area ID of the detection information recorded in step S104 (step S108). Here, two detection areas A being adjacent means that there is only one connection point P between the two detection areas A.

When the detection area A pertaining to the immediately preceding detection information is adjacent to the detection area A pertaining to the detection information recorded in step S104 (step S108: YES), the toll collecting device 200 ends the entry end specification processing. In this way, when the immediately preceding detection information is stored in the detection information storage unit 206, the toll collecting device 200 does not specify the entry side end in step S106 in the entry end specification processing. This is because the entry end has already been specified in the entry end specification processing performed by the toll collecting device 200 before a current entry end specification processing. In other words, the entry side end of the transit range of the vehicle C for which the immediately preceding detection information is stored in the detection information storage unit 206 is one specified in the entry end specification processing previously performed.

On the other hand, when the detection area A pertaining to the immediately preceding detection information is not adjacent to the detection area A pertaining to the detection information recorded in step S104 (step S108: NO), the range specification unit 209 specifies the connection point P adjacent a downstream side of the detection area A indicated by the area ID of the immediately preceding detection information, as the exit side end of the transit range (hereinafter referred to as the “previous transit range”) of the vehicle C indicated by the vehicle ID of the immediately preceding detection information (step S109). As described above, at this time, in the range storage unit 208, a connection point ID indicating the entry side end of the previous transit range of the vehicle C is recorded in the entry end specification processing that was performed previously. The range specification unit 209 records in the range storage unit 208 the connection point ID, which is the identification information of the connection point P specified in step S108, as the exit side end of the previous transit range (step S110), associated with the vehicle ID. As a result, the range storage unit 208 stores the connection point ID indicating the entry side end and the connection point ID indicating the exit side end of the previous transit range associated with a certain vehicle ID. Next, the toll collecting device 200 performs charge processing to be described later based on a specified previous transit range (step S111). This thereby enables the toll collecting device 200 to charge for each transit range, even in the case where the vehicle C enters the main road R1 a plurality of times within a short period of time.

Further, the range specification unit 209 specifies the connection point P adjacent the upstream side of the detection area A indicated by the area ID of the detection information recorded in step S104 as the entry side end of the transit range of the vehicle C indicated by the vehicle ID of the detection information (hereinafter, referred to as the “current transit range”) (step S112). In other words, in a case where the detection area A indicated by the area ID of the immediately preceding detection information is not adjacent to the detection area A indicated by the area ID of the detection information recorded in step S104, the toll collecting device 200 regards that the vehicle C has traveled two different transit ranges (the previous transit range and the current transit range). In other words, the toll collecting device 200 regards that the vehicle C, after exiting from the main road R1 at the connection point adjacent the detection area A indicated by the area ID of the immediately preceding detection information, entered the main road R1 from the connection point adjacent the detection area A indicated by the area ID of the detection information recorded in step S104. Then, the range specification unit 209 records in the range storage unit 208 the connection point ID, which is the identification information of the connection point P specified in step S110, associated with the vehicle ID as the entry side end of the current transit range (step S113), and ends the entry end specification processing.

The entry end specification processing described above enables the toll collecting device 200 to specify the entry side end of the transit range of the vehicle C.

Also, the toll collecting device 200 executes an exit end specification processing described below every time when a certain period of time (for example, one hour) elapses.

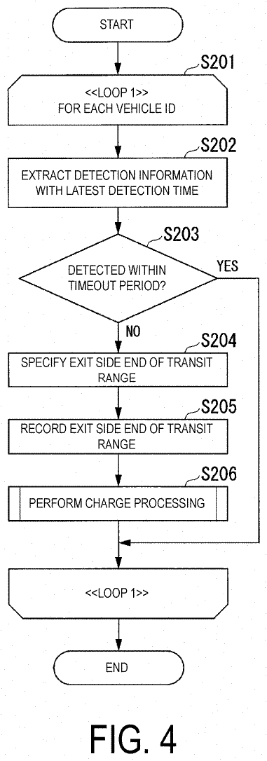

FIG. 4 is a flowchart illustrating an exit end specification processing by the toll collecting device according to the first embodiment.

When the toll collecting device 200 starts the exit end specification processing, the range specification unit 209 selects the vehicle IDs stored in the detection information storage unit 206 one by one, and executes processes from step S202 to step S206 (Step S201) described below.

First, the range specification unit 209 extracts the detection information associated with the selected vehicle ID and having the latest detection time among the detection information stored in the detection information storage unit 206 (step S202). Next, the range specification unit 209 determines whether the detection time of the extracted detection information is within the predetermined timeout period (for example, 24 hours) prior to the current time (step S203). In other words, the range specification unit 209 determines whether the same vehicle IDs within the timeout period have been detected.

When the detection time of the detection information extracted in step S202 is not within the predetermined timeout period prior to the current time (step S203: NO), the range specification unit 209 specifies the connection point P adjacent the downstream side of the detection area A indicated by the area ID of the detection information, as the exit side end of the transit range of the vehicle C indicated by the vehicle ID of the detection information (step S204). At this time, in the range storage unit 208, the connection point ID indicating the entry side end of the transit range of the vehicle C is recorded by the process of the above-described step S106. The range specification unit 209 records in the range storage unit 208 the connection point ID of the specified connection point P, as the exit side end of the transit range, associated with the vehicle ID (step S205). As a result, the range storage unit 208 stores the connection point ID indicating the entry side end of the transit range and the connection point ID indicating the exit side end associated with a certain vehicle ID. Next, the toll collecting device 200 performs charge processing (to be described later) based on the specified transit range (step S206).

On the other hand, when the detection time of the detection information extracted in step S202 is within a predetermined timeout period prior to the current time (step S202: YES), no determination of exit is made.

The above-described exit end specification processing enables the toll collecting device 200 to specify the exit side end of the transit range of the vehicle C.

Next, a process flow of charge processing by the toll collecting device 200 will be described.

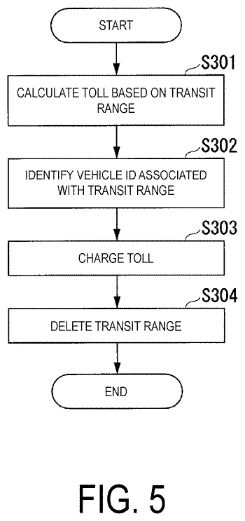

FIG. 5 is a flowchart illustrating a charging process by the toll collecting device according to the first embodiment.

When the connection point ID indicating the entry side end and the connection point ID indicating the exit side end of the transit range of a certain vehicle C are recorded in the range storage unit 208, the toll calculation unit 210 calculates the toll for travel on the road R1 by the vehicle C based on the transit range stored in the range storage unit 208 (step S301). Specifically, the toll calculation unit 210 calculates the toll according to a table in which the transit ranges and the tolls are associated. The charge processing unit 211 identifies the vehicle ID associated with the transit range in the range storage unit 208 (step S302). Next, the charge processing unit 211 charges the toll calculated by the toll calculation unit 210 according to the payment method stored in the charge information storage unit 202 associated with the specified vehicle ID (step S303). Then, the charge processing unit 211 deletes the transit range information for which charging has been completed from the range storage unit 208 (step S304).

### Operational Effects

As described above, according to the present embodiment, the toll collecting device 200 determines the transit range that the vehicle C traveled based on the vehicle ID acquired from the identification information reading device 100 provided in each detection area A of the main road R1. This enables the toll collecting device 200 according to the present embodiment to specify the transit range on the main road R1 of each vehicle C without dividing the entry or exit of the main road R1 into a single lane.

Even in a known toll collection system, there is a possibility that recognition accuracy of the vehicles can be improved without dividing the tollgate into single lanes, by providing many vehicle recognition devices at the tollgate. However, space of the tollgate is limited, and when the space of the tollgate is narrow, it is difficult to provide many vehicle recognition devices. By contrast, the main road R1 has a larger space than the exit road R3 and the entrance road R2. Therefore, a sufficient number of identification information reading devices 100 can be disposed in the detection area A in order to secure required recognition accuracy of the vehicle C.

### Second Embodiment

A detailed description of embodiments of the toll collection system according to the second embodiment will follow with reference to the drawings.

### Overall Configuration

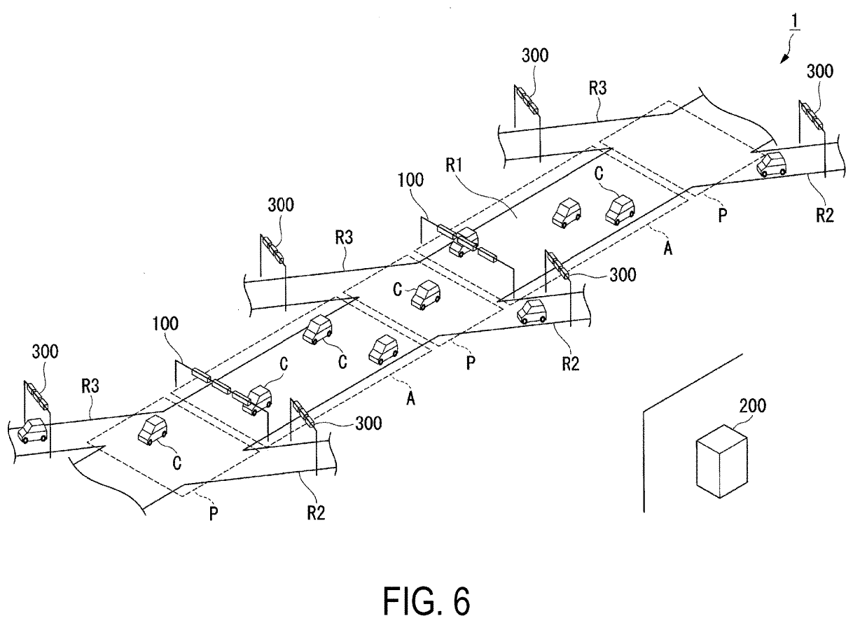

FIG. 6 is a diagram illustrating an overall configuration of a toll collection system according to the second embodiment. The toll collection system 1 according to the second embodiment further includes an auxiliary reading device 300 in addition to the configuration of the first embodiment.

The auxiliary reading device 300 is provided in the entrance road R2 and the exit road R3. The auxiliary reading device 300 reads from the vehicle C that travels the entrance road R2 or the exit road R3 the vehicle ID to identify the vehicle C. Examples of the auxiliary reading device 300 include a license plate recognition device that reads the vehicle ID displayed on the license plate of the vehicle C and an antenna that reads the vehicle ID from the onboard unit mounted on the vehicle C. Since the entrance road R2 and the exit road R3 are narrower than the main road R1, the accuracy of reading the vehicle ID by the auxiliary reading device 300 may be lower than the reading accuracy of the identification information reading device 100.

### Functional Configuration

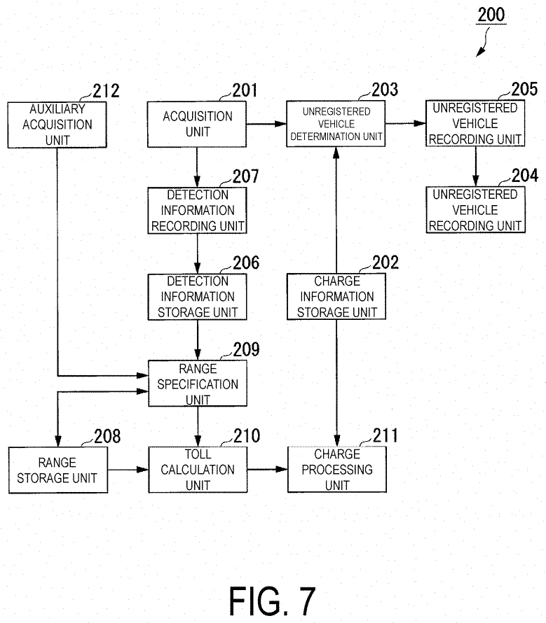

FIG. 7 is a schematic block diagram illustrating a functional configuration of the toll collecting device according to the second embodiment.

In addition to the configuration of the first embodiment, the toll collecting device 200 further includes an auxiliary acquisition unit 212.

The auxiliary acquisition unit 212 obtains, from the auxiliary reading device 300, the vehicle ID read by the auxiliary reading device 300.

### Process Flow of Toll Collecting Device

In addition to the processing according to the first embodiment, the toll collecting device 200 according to the second embodiment performs the following entry and exit specification processing each time the auxiliary reading device 300 reads the vehicle ID.

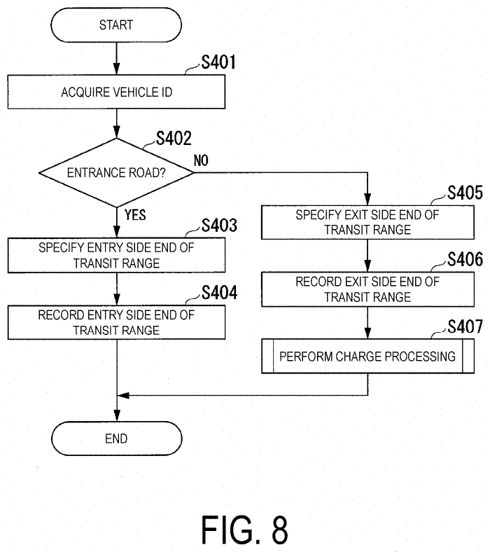

FIG. 8 is a flowchart illustrating a process of specifying entry and exit by the toll collecting device according to the second embodiment.

When the auxiliary reading device 300 reads the vehicle ID, the auxiliary acquisition unit 212 of the toll collecting device 200 acquires the vehicle ID from the auxiliary reading device 300 (step S401). Next, the range specification unit 209 determines whether the branch road on which the auxiliary reading device 300 that has read the vehicle ID is provided is the entrance road R2 (step S402). When the auxiliary reading device 300 that has read the vehicle ID is provided on the entrance road R2 (step S402: YES), the range specification unit 209 specifies the connecting point P that connects to the branch road provided with the auxiliary reading device 300 that has read the vehicle ID acquired in step S401 as the entry side end of the transit range of the vehicle C indicated by the vehicle ID (step S403). Then, the range specification unit 209 records in the range storage unit 208 the connection point ID, which is the identification information of the connection point P, as the entry side end of the transit range, associating the connection point ID with the vehicle ID (step S404), and completes the end specification process.

On the other hand, when the auxiliary reading device 300 that has read the vehicle ID is provided on the exit road R3 (step S402: NO), the range specification unit 209 specifies the connecting point P that connects to the branch road provided with the auxiliary reading device 300 that has read the vehicle ID acquired in step S401 as the exit side end of the transit range of the vehicle C indicated by the vehicle ID (step S405). Then, the range specification unit 209 records in the range storage unit 208 the connection point ID, which is the identification information of the connection point P, as the exit side end of the transit range associated with the vehicle ID (step S406). As a result, the range storage unit 208 stores the connection point ID indicating the entry side end of the transit range and the connection point ID indicating the exit side end associated with a certain vehicle ID. Next, the toll collecting device 200 performs the above-described charging process based on the specified transit range (step S407), and completes the end specifying process.

### Operational Effects

As described above, when the toll collecting device 200 according to the second embodiment acquires the vehicle ID from the auxiliary reading device 300 provided on the branch road, the toll collecting device 200 according to the second embodiment specifies the connection point P that connects to the branch road as the end of the transit range of the vehicle C. This thereby enables the toll collecting device 200 to quickly specify entry and exit of the vehicle C to and from the main road R1 without waiting for a lapse of the timeout period as in the case of the first embodiment.

Even in a case where the auxiliary reading device 300 fails to read the vehicle ID, the transit range of the vehicle C can be reliably specified by the toll collecting device 200 executing the above-described entry end specification processing (FIG. 3) and the exit end specification processing (FIG. 4).

### Third Embodiment

A detailed description of embodiments of the toll collection system according to the third embodiment will follow with reference to the drawings. The toll collection system 1 according to the third embodiment specifies the transit range of the vehicle C based on the information received from a mobile terminal (not illustrated) owned by the user of the vehicle C in addition to the vehicle ID read by the identification information reading device 100. The toll collection system 1 according to the third embodiment has the same configuration as that of the first embodiment.

### Functional Configuration

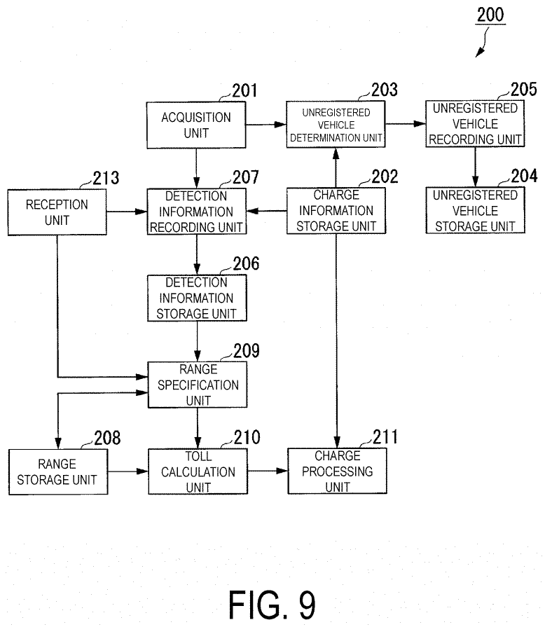

FIG. 9 is a schematic block diagram illustrating a functional configuration of the toll collecting device according to the third embodiment.

In addition to the configuration of the first embodiment, the toll collecting device 200 further includes a reception unit 213.

The reception unit 213 receives transit information that is information on the travel on the main road R1 from a mobile terminal (not illustrated) possessed by the user of the vehicle C. Specifically, the transit information is the area ID of the detection area A traveled by the vehicle C, and exit information indicating that the vehicle C exited from the main road R1.

The mobile terminal identifies a position where the vehicle C is present based on NSS (Navigation Satellite System) or identification information of radio communication, specifies the detection area A being traveled based on the position, and determines whether the vehicle C exited from the main road R1. Examples of NSS include GPS (Global Positioning System), Quasi-Zenith Satellite System (QZSS), and the like. Examples of the identification information by wireless communication include identification information of a partner device of Bluetooth (trade name) communication, a beacon signal transmitted from an access point of wireless LAN (Local Access Network) communication, and the like.

Further, the charge information storage unit 202 of the toll collecting device 200 stores the terminal ID, which is the identification information of the mobile terminal, in addition to and associated with the vehicle ID and the payment method.

### Process Flow of Toll Collecting Device

In addition to the operation of the first embodiment, the toll collecting device 200 according to the third embodiment executes the following transit information reception processing every time the mobile terminal transmits the transit information.

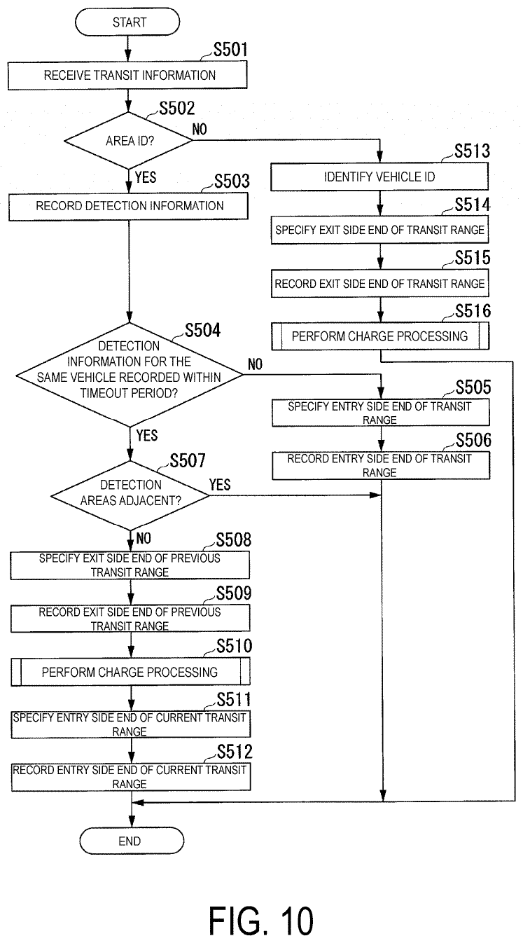

FIG. 10 is a flowchart illustrating a process of receiving transit information by the toll collecting device according to the third embodiment.

When the mobile terminal transmits the transit information, the reception unit 213 of the toll collecting device 200 acquires the transit information from the mobile terminal (step S501). Next, the reception unit 213 determines whether the received transit information indicates the area ID of the detection area A where the vehicle C is traveling or indicates the exit information (step S502). When the received transit information indicates the area ID (step S502: YES), the detection information recording unit 207 records the detection information in the detection information storage unit 206 based on the acquired transit information (step S503). Specifically, the detection information recording unit 207 reads from the charge information storage unit 202 the vehicle ID associated with the terminal ID of the mobile terminal of a recipient of the received transit information, and records the read vehicle ID in the detection information storage unit 206, associating the vehicle ID with the area ID indicated by the transit information and the time of reception.

Next, the range specification unit 209 determines whether the immediately preceding detection information is stored in the detection information storage unit 206 (step S504).

When the immediately preceding detection information is not stored in the detection information storage unit 206 (step S504: NO), the range specification unit 209 specifies the entry side end of the transit range of the vehicle C indicated by the vehicle ID of the detection information recorded in step S503 (step S505). Specifically, the range specification unit 209 specifies the connecting point P adjacent the upstream side of the detection area A indicated by the area ID of the detection information recorded in step S503 as the entry side end of the travel area of the vehicle C indicated by the vehicle ID of the detection information. Then, the range specification unit 209 records in the range storage unit 208 the connection point ID, which is the identification information of the connection point P, as the entry side end of the transit range, associating the connection point ID with the vehicle ID (step S506), and ends the transit information reception processing.

Conversely, when immediately preceding detection information is stored in the detection information storage unit 206 (step S504: YES), the range specification unit 209 determines whether the detection area A indicated by the area ID of the immediately preceding detection information having the latest detection time among the immediately preceding detection information is an area adjacent to the detection area A indicated by the area ID of the detection information recorded in step S503 (step S507).

When the detection area A pertaining to the immediately preceding detection information is adjacent to the detection area A pertaining to the detection information recorded in step S503 (step S507: YES), the toll collecting device 200 ends the entry end specification processing.

On the other hand, when the detection area A pertaining to the immediately preceding detection information is not adjacent to the detection area A pertaining to the detection information recorded in step S503 (step S507: NO), the range specification unit 209 specifies the connection point P adjacent the downstream side of the detection area A indicated by the area ID of the immediately preceding detection information, as the exit side end of the transit range (the previous transit range) of the vehicle C indicated by the vehicle ID of the immediately preceding detection information (step S508). The range specification unit 209 records in the range storage unit 208 the connection point ID, which is the identification information of the connection point P specified in step S507, as the exit side end of the previous transit range, associated with the vehicle ID (step S509). Next, the toll collecting device 200 performs charge processing to be described later based on the specified previous transit range (step S510).

Further, the range specification unit 209 specifies the connecting point P adjacent the upstream side of the detection area A indicated by the area ID of the detection information recorded in step S503, as the entry side end of the transit range of the vehicle C indicated by the vehicle ID of the detection information (the current transit range) (step S511). Then, the range specification unit 209 records in the range storage unit 208 the connection point ID, which is the identification information of the connection point P specified in step S509, associated with the vehicle ID as the entry side end of the current transit range (step S512), and ends the entry end specification processing.

On the other hand, when the transit information received in step S501 indicates the exit information (step S502: NO), the range specification unit 209 identifies the vehicle ID recorded in the charge information storage unit 202 associated with the terminal ID of the mobile terminal of the sender of the transit information (step S513). Next, the range specification unit 209 extracts the detection information having the latest detection time among the detection information pertaining to the identified vehicle ID. Next, the range specification unit 209 specifies the connection point P adjacent the downstream side of the detection area A indicated by the area ID of the extracted detection information as the exit side end of the transit range of the vehicle C indicated by the vehicle ID (Step S514). Then, the range specification unit 209 records in the range storage unit 208 the connection point ID, which is the identification information of the connection point P, as the exit side end of the transit range associated with the vehicle ID (step S515). Then, the toll collecting device 200 performs the above-described charge processing based on the specified transit range (step S516), and ends the transit information reception processing.

### Operational Effects

In this way, according to the present embodiment, the toll collecting device 200 receives the transit information regarding the travel on the main road R1 by the vehicle C from the mobile terminal owned by the user, and specifies the transit range of the vehicle C based on the transit information and the detection information. This thereby enables the recognition accuracy of the vehicle C by the toll collecting device 200 to be improved.

Specifically, the mobile terminal is able to complement a function of the identification information reading device 100 due to the transit information including the area ID of the detection area in which the vehicle C used by the user travels. In addition, the toll collecting device 200 is able to identify the exit of the vehicle C from the main road R1 without waiting for the lapse of the timeout period as in the case of the first embodiment, due to the transit information including the exit information indicating that the vehicle C used by the user exited from the main road R1.

In other embodiments, identification information of the entrance road R2 or the exit road R3 traveled by the vehicle C used by the user may be included in the transit information. In this case, similarly to the second embodiment, the identification information reading device 100 is able to identify the entry to or exit from the main road R1 of the vehicle C without waiting for the lapse of the time-out period.

### Modified Example

Although an embodiment has been described in detail with reference to the drawings, specific configurations are not limited to those described above, and various design changes and the like can be made.

For example, in the above-described embodiments, a case where the transit range evaluation device is disposed in the toll collecting device 200 has been described, but the present invention is not limited thereto. In other embodiments, it may be mounted, for example, in another device such as a traffic volume measuring device that measures the traffic in each detection area A of the main road R1.

Further, in the above-described embodiments, information in which the vehicle ID, the area ID, and the detection time are associated with each other is recorded in the unregistered vehicle storage unit 204 as the unregistered vehicle information, but it is not limited thereto.

For example, the toll collecting device 200 according to other embodiments may record as evidence an image captured by a camera which is one of the identification information reading devices 100, in the unregistered vehicle storage unit 204 associating the captured image with the vehicle ID.

Further, in the above-described embodiments, it is necessary to register a charging method in the charge information storage unit 202 in advance to travel on the main road R1, but the present invention is not limited thereto. In other embodiments, for example, when an administrator of the main road R1 can use information for specifying a vehicle ID and an individual, the main road R1 may be used without a registration in the charge information storage unit 202. In this case, there is no need for the toll collecting device 200 to determine the unregistered vehicle.

### Computer Configuration

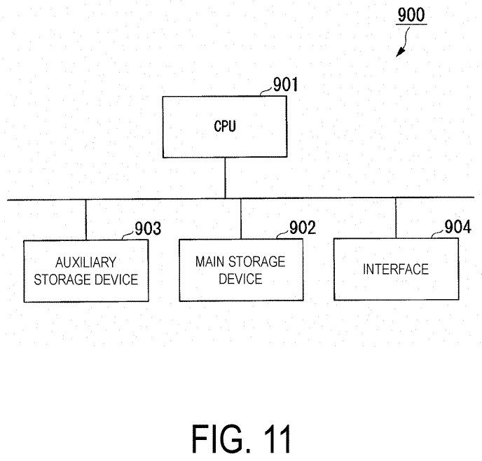

FIG. 11 is a schematic block diagram illustrating a computer configuration according to at least one of the embodiments.

A computer 900 includes a CPU 901, a main storage device 902, an auxiliary storage device 903, and an interface 904.

The toll collecting device 200 described above is implemented in the computer 900. The operations of the respective processing units described above are stored in the auxiliary storage device 903 in the form of a program. The CPU 901 reads the program from the auxiliary storage device 903, develops the program in the main storage device 902, and executes the above processes according to the program. Further, the CPU 901 secures a storage area corresponding to each of the above-described storage units in the main storage device 902 according to the program.

In at least one embodiment, the auxiliary storage device 903 is an example of a non-transitory tangible medium. Other examples of the non-transitory tangible medium include a magnetic disk, a magneto-optical disk, a Compact Disc Read Only Memory (CD-ROM), a Digital Versatile Disc Read Only Memory (DVD-ROM), Semiconductor memory, and the like connected via the interface 904. Also, if this program is distributed to the computer 900 via a communication line, the computer 900 that receives the distribution may develop the program on the main storage device 902 and execute the above-described processes.

Also, the program may be a program for realizing part of the functions described above.

In addition, the program may be a so-called differential file (differential program) that realizes the above-described functions in combination with other programs already stored in the auxiliary storage device 903.

### INDUSTRIAL APPLICABILITY

According to at least one aspect of the aspects described above, a transit range evaluation device is capable of specifying a transit range on a main road traveled by each vehicle, without disposing a tollgate separated into single lanes at an entrance or an exit of the main road.

### REFERENCE SIGNS LIST

1 Toll collection system
100 Identification information reading device
200 Toll collecting device
201 Acquisition unit
202 Charge information storage unit
203 Unregistered vehicle determination unit
204 Unregistered vehicle storage unit
205 Unregistered vehicle recording unit
206 Detection information storage unit
207 Detection information recording unit
208 Range storage unit
209 Range specification unit
210 Toll calculation unit
211 Charge processing unit
R1 Main road

### C Vehicle

R2 Entrance road
R3 Exit road
P Connection point
A Detection area

1. A transit range evaluation device comprising:
an acquisition unit configured to acquire vehicle identification information for identifying a vehicle from an identification information reading device disposed in individual detection areas of a main road to be monitored, the detection areas being partitioned at connection points connecting the main road and branch roads;
a detection information recording unit configured to record detection information in a detection information storage unit, wherein vehicle identification information, a detection time of the vehicle identification information, and the detection area in which the vehicle identification information is detected, are associated with the detection information; and
a range specification unit configured to specify a transit range on the main road in which the vehicle indicated by the vehicle identification information traveled, based on the detection information recorded in the detection information storage unit.

2. A transit range evaluation device according to claim 1, wherein
in a case where a vehicle identification information is not acquired again before a predetermined amount of time passes after a time in which the vehicle identification information has been last acquired, the range specification unit is configured to specify, out of the connection points, one adjacent a downstream side of the detection area in which the vehicle identification information has been last acquired, as an exit side end of the transit range of the vehicle indicated by the vehicle identification information.

3. A transit range evaluation device according to claim 1, wherein
in a case where a vehicle identification information is not acquired within a predetermined amount of time after a time in which the vehicle identification information has been acquired, the range specification unit is configured to specify, out of the connection points, one adjacent an upstream side of the detection area in which the vehicle identification information has been acquired, as an entry side end of the transit range of the vehicle indicated by the vehicle identification information.

4. A transit range evaluation device according to claim 1, wherein
in a case where a first detection area in which a vehicle identification information is acquired and a second detection area in which the vehicle identification information has been detected immediately prior to a detection of the vehicle identification information in the first detection area are not adjacent to each other, the range specification unit is configured to specify, out of the connection points, one adjacent the upstream side of the first detection area as an entry side end of a first transit range of the vehicle indicated by the vehicle identification information, and to specify, out of the connection points, one adjacent the downstream side of the second detection area as an exit side end of a second transit range of the vehicle indicated by the vehicle identification information.

5. A transit range evaluation device according to claim 1, further comprising an auxiliary acquisition unit configured to acquire vehicle identification information from an identification information reading device disposed in the branch road,
wherein, in a case where a vehicle identification information is acquired by the auxiliary acquisition unit, the range specification unit is configured to specify the connection point connected to the branch road in which the vehicle identification information is acquired, as an end of the transit range of the vehicle indicated by the vehicle identification information.

6. A transit range evaluation device according to claim 1, further comprising a reception unit configured to receive, from a mobile terminal possessed by a user, transit information that is information relating to travel on the main road by a vehicle used by the user,
wherein the range specification unit is configured to specify the transit range based on transit information received by the reception unit and the detection information recorded in the detection information storage unit.

7. A transit range evaluation device according to claim 6, wherein the transit information includes information indicating the detection area or the branch road traveled by a vehicle used by the user.

8. A transit range evaluation device according to claim 6, wherein
the transit information includes information indicating that a vehicle used by the user exited from the main road, and
the range specification unit is configured to specify the transit range based on the detection information recorded in the detection information storage unit, the detection information being recorded prior to a time of reception of the transit information indicating an exit from the main road.

9. A transit range evaluation device according to claim 1, further comprising a toll calculation unit configured to calculate a toll to be charged to the vehicle based on the transit range specified by the range specification unit.

10. A transit range evaluation system comprising:
an identification information reading device disposed in individual detection areas of a main road to be monitored, the detection areas being partitioned at connection points connecting the main road and branch roads; and
a transit range evaluation device according to claim 1.

11. A transit range evaluation method comprising steps of:
acquiring vehicle identification information for identifying a vehicle from an identification information reading device disposed in individual detection areas of a main road to be monitored, the detection areas being partitioned at connection points connecting the main road and branch roads;
recording detection information in a detection information storage unit, wherein vehicle identification information, a detection time of the vehicle identification information, and the detection area in which the vehicle identification information is detected, are associated with the detection information; and
specifying transit range on the main road in which the vehicle indicated by the vehicle identification information traveled, based on the detection information recorded in the detection information storage unit.

12. A program to cause a computer to function as:
an acquisition unit configured to acquire vehicle identification information for identifying a vehicle from an identification information reading device disposed in individual detection areas of a main road to be monitored, the detection areas being partitioned at connection points connecting the main road and branch roads;
a detection information recording unit configured to record detection information in a detection information storage unit, wherein vehicle identification information, a detection time of the vehicle identification information, and the detection area in which the vehicle identification information is detected, are associated with the detection information; and
a range specification unit configured to specify transit range on the main road in which the vehicle indicated by the vehicle identification information traveled, based on the detection information recorded in the detection information storage unit.
